(19) United States
(12) Patent Application Publication
(10) Pub. No.: US 2026/0132354 A1
(43) Pub. Date: May 14, 2026

(54) Method and reactor for degumming triglyceride oils

(71) Applicant: ARISDYNE SYSTEMS, INC., MIDDLEBURG HEIGHTS, OH (US)

(72) Inventor: Oleg Kozyuk, North Ridgeville, OH (US)

(21) Appl. No.: 19/374,716

(22) Filed: Oct. 30, 2025

Related U.S. Application Data
(60) Provisional application No. 63/719,210, filed on Nov. 12, 2024.

(51) Int. Cl. C11B 3/16; C11B 3/00; C11B 3/04; C11B 3/06

(52) U.S. Cl. CPC C11B 3/16; C11B 3/001; C11B 3/005; C11B 3/04; C11B 3/06

(57) ABSTRACT

A method and reactor for degumming triglyceride oils. An aqueous base is mixed with an acid-treated oil stream to obtain a pretreated oil mixture that is subjected to oscillated pressure impulses by passing a flow of the pretreated oil mixture through a channel. A water hammer hydraulic pulse pressure is generated inside the channel by periodically closing an inlet and an outlet of the channel simultaneously for a selective closing time period. The method reduces the formation of soap stocks or soaps during neutralization of the vegetable oil. A decrease in the number of soaps formed during vegetable oil refining can reduce the amount of oil loss and the costs related to separating and purifying the refined vegetable oil product.

This application claims priority to and any other benefit of U.S. Provisional Patent Application Ser. No. 63/719,210 filed Nov. 12, 2024, the contents of which are incorporated herein in their entirety by reference.

### TECHNICAL FIELD

The invention relates to an improved process for degumming triglyceride oils and, more particularly, to improved processes for degumming vegetable oils having free fatty acids and phosphatides.

### BACKGROUND

Vegetable oils are typically pressed or extracted from vegetable sources. Almost every vegetable oil contains some form of phosphatides (hydratable or non-hydratable), commonly known as gums. Soybean oil contains about 1-3%, corn oil 0.6-0.9%, sunflower oil 0.5-0.9%, and canola oil (crude) 1-3% of gums. Gums can be partially or totally removed from vegetable oils through several known degumming processes. The most used processes in the industry include water degumming, acid degumming, caustic refining, and enzymatic degumming. Exemplary processes are described in U.S. Pat. Nos. 4,049,686; 5,239,096; 5,264,367; 5,286,886; 6,001,640; 6,033,706; 7,494,676; 7,544,820; and U.S. Patent Applications Nos. 2007/0134777, 2008/0182322, and 2012/0258017.

Further improvements in purifying vegetable oil have been sought, particularly in obtaining a finely dispersed acid/base solution in the oil by using high shear equipment.

A method disclosed in U.S. Pat. No. 4,240,972 involves adding an acid to a heated stream of crude vegetable oil and then immediately passing the mixture through a static mixer, intensively mixing for a fraction of a second to produce an acid-in-oil dispersion with acid droplets smaller than 10 microns. The mixture is then separated into an oil phase and an aqueous phase containing the phosphatides. Static mixers for this process include the Kenics Static Mixer, Komax Motionless Mixer, Series 50 In-Line Blender by Lightnin, Ross Motionless Mixers, and Sulzer Static Mixer. These devices are tubular structures with fixed mixing elements inside that accomplish flow division and radial mixing simultaneously. The static mixer is sized to give a flow velocity of about 3.0 m/sec.-7.6 m/sec.

U.S. Pat. Nos. 4,698,185 and 6,015,915 describe processes for degumming vegetable oil using high shear Ultra-Turrax rotor/stator apparatus.

U.S. Pat. No. 6,172,248 outlines improved methods for refining vegetable oils. In an organic acid refining process, vegetable oil is combined with a dilute aqueous organic acid solution and subjected to high shear to finely disperse the acid solution in the oil. High shear mixing in this context typically involves an impeller operating at a speed of about 900 to 1,500 rpm, generating blade tip speeds of 4000 to 9000 ft/min, which produces high shear flow velocities of at least 45 feet per second.

U.S. Pat. No. 8,491,856 describes a system for stripping fatty acids from triglycerides using a high shear device with at least one rotor. The rotor rotates at a tip speed of at least 22.9 m/s (4,500 ft/min) during the formation of the dispersion, with energy expenditure greater than 1000 W/m³. The high shear device includes at least one stator and rotor, separated by a clearance, and is known to generate hydrodynamic cavitation in fluids.

Some advancements have been made in oil treatment processes, such as improved mixing of chemicals in caustic soda and acid treatments using hydrodynamic cavitation reactors. Such processes are found in U.S. Pat. Nos. 8,911,808; 8,945,644; 9,410,109; 9,453,180; 9,556,399; 9,765,279; and 9,845,442.

However, the cavitation-based alkali neutralization process has significant drawbacks, primarily related to soaps formation and oil losses. Cavitation generates very small alkali droplets, which increases the saponification rate of oil, and entrapment neutral oil soap stock, leading to higher oil losses. To minimize separation loss, the process design should aim to soap formation during neutralization.

### SUMMARY

A method and reactor for degumming triglyceride oils. The method includes the steps of mixing an aqueous base with the acid-treated oil stream to obtain a pretreated mixture, subjecting the pretreated mixture to oscillated pressure impulses by passing a flow of the liquid pretreated mixture through at least one channel, and generating water hammer hydraulic pulse pressure inside the channel by periodically closing the inlet and outlet of said channel simultaneously for a closing time period calculated using the equation:

t≥2L/c,

where t is the time in seconds that it takes to close fully the inlet and outlet channel, L is the length of the channel in meters, and c is the speed of sound in said liquid pretreated mixture in meters per second.

A reactor for degumming vegetable oils that includes a housing with an inlet, through which a liquid pretreated mixture is introduced into the chamber, and an outlet positioned downstream of the inlet for discharging the treated mixture. Inside the chamber, two rotational disc valves are mounted on a central shaft, each disc having a series of circumferentially arranged channels extending through the rotatable plates, parallel to the chamber's central axis.

A stationary disk plate is joined to the inner wall of the chamber, positioned between the two rotatable discs. The stationary plate is perpendicular to the chamber's central axis and is closely adjacent to the rotatable discs. It contains at least one elongated channel extending through the stationary plate, also parallel to the central axis of the chamber.

The radii from the chamber's central axis to the central axes of all channels are identical for both the stationery and rotary disc valves. Additionally, the circumferential channels on the rotating disc valves have coinciding central axes. The circumferential distance between neighboring channels on the rotatable disc valves is at least equal to the diameter of the channel at the stationary disk plate. A reactor for degumming vegetable oils can have 2, 3, 4, 5.6, 7, 8, 9, 10 and more than one set of stationary and rotatable disks arranged in series axially in the chamber and are separated from one another by respective spacings. Shaft is connected to a motive means effective to rotate the rotatable disk valves.

### BRIEF DESCRIPTION OF THE DRAWINGS

FIG. 1 shows a longitudinal cross-sectional view of a reactor according to the invention that can be used for conducting degumming vegetable oils.

FIG. 2 shows a cross-sectional view of the reactor shown in FIG. 1, showing the configuration of a rotatable disk and viewed partially through the holes therein.

### DETAILED DESCRIPTION

Herein, when a range, such as 5-25 (or 5 to 25) is given, this means preferably at least or not less than 5 and, separately and independently, preferably less than or not more than 25.

Referring to the drawings, which are for purposes of illustrating embodiments of the invention only, and not for purposes of limiting the same.

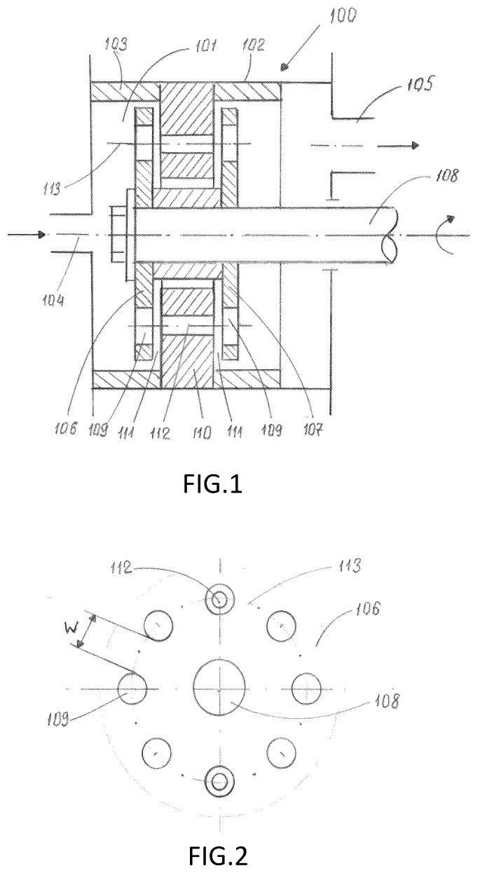

In one embodiment, FIG. 1 shows a cross-section of a reactor for degumming vegetable oils. As shown, reactor 100 has a longitudinal axis (“axis”) denoted by the broken line running central to shaft 108.

Reactor 100 includes housing 102 that partially defines chamber 101. Housing 102 has an inner cylindrical wall surface 103 parallel to and facing towards the longitudinal axis (“axis”) of the reactor, inlet 104, through which a pretreated oil mixture is introduced into the chamber, and an outlet 105 positioned downstream of the inlet for discharging the treated mixture.

Inside chamber 101, two rotational disc valves 106 and 107 are mounted on a central shaft 108. Rotational disc valves 106 and 107 have a series of circumferentially arranged channels 109 extending through the rotatable disc valve plates, parallel to the chamber's central axis. Eight channels 109 are shown by FIG. 2, but there can alternatively be 2, 3, 5, 6, 7, 9, 10, 11, 12, 16 20 or more.

As shown by FIG. 1, stationary disk plate 110 is mounted to the inner wall of chamber 101 housing and positioned between the two rotatable discs 106 and 107. The stationary disc plate 110 is perpendicular to the chamber's central axis and is closely adjacent to the rotatable discs 106 and 107. The gap 111 between the rotatable discs 106, 107 and stationary disc plate 110 is preferably substantially uniform and is preferably 0.6-4.0, 0.6-3.0, 0.6-2.5, 0.6-2.0, 0.6-1.5 or 0.6-1.0, millimeters.

Stationary disk plate 110 contains at least one elongated channel 112 extending through stationary plate 110, and also parallel to the central axis of chamber 101.

The radii from the chamber's central axis to the central axes 113 of channels 109 and 112 are identical for both the stationary disk plate 110 and rotary disc valves 106 and 107.

Each circumferential channel 109 on the rotating disc valves 106 and 107 have coinciding central axes 113 and circumferential distance W between neighboring channels 109 on the rotating disc valves 106 and 107 is at least equal to the diameter of the channel 112 at the stationary disk plate 110.

A reactor for degumming vegetable oils can have 2, 3, 4, 5.6, 7, 8, 9, 10 and more than one set of stationary 110 and rotatable 106 and 107 disks arranged in series axially in chamber 101 and are separated from one another by respective spacings.

Shaft 108 is connected to a motive which means effective rotating the rotatable disk valves 106 and 107.

Each rotatable disc valves 106 and 107 channel 109 is preferably cylindrical (alternatively rectangular or any other shape in cross section). The preferably rotates at least 500, 700, 900, 1000, 1500, 2000, 2500, 3000, 3500, 4000, 5000, 6000, 7500 or 10,000 RPM. The faster the rotatable disc valves 106 and 107 rotate, the shorter the closer time of the channel 112 in stationary disk plate 110.

The base is added to the acid-treated vegetable oil to form a pretreated mixture. The formed pretreated mixture is immediately passed in reactor 100 such that the formed pretreated mixture does not experience retention time or mixing prior to passing through the reactor 100. For example, the base can be metered into an acid-treated vegetable oil to form a pretreated mixture that is in fluid connection to the inlet 104 of the reactor 100.

A pretreated mixture entered into reactor 100 through inlet 104 under pressure at low velocity and forced through stationary disk 110 channel 112 where the velocity is increased.

The pretreated mixture can be fed to the reactor 100 by a pump. Preferably, the pretreated mixture is fed to the reactor 100 at a pre-determined inlet pressure, for example, in the range of 10 to 300 psi, or at least 20, 30, 60, 100, 150 or 200 psi.

As two rotational disc valves 106 and 107 rotate and takes the entrance and exit end of the stationary disk 110 channel 112 from an open position to a closed position, the sudden blockage of flowing liquid pretreated mixture through the stationary disk channel 112 creates a sudden change in liquid velocity and the kinetic energy is converted to pressure energy, in other words a water hammers hydraulic pulse pressure is produced inside stationary disk 110 channel 112. The time T required for the pressure wave to travel from the closed back rotational disc valve 107 to the closed front rotational disc valve 106 and back to the back valve 107 is pressure wave period of oscillation T=2L/c.

The rotational disc valves 106 and 107 times of closure t channel 112 longer than travel time T of the shock wave, t≥2L/c, then the closure is said to be gradual, and the increased pressure is

ΔP=ρLV/t,

where, V—initial velocity of liquid flowing in the stationary disk channel before closure, t—time of closure, Lμstationary disk channel, and ρ—liquid pretreated mixture density, c—speed of sound in the liquid.

In the case of gradual closure, the compression and rarefaction phases have the same duration determined by the travel time T of the shock wave from the closed back rotational disc valve 107 to the closed front rotational disc valve 106 and back to the back valve 107, the disturbances from shock wave do not go any far from the channel 112, and the period of these oscillations is completely determined by the length of the channel 112 and the speed of the shock wave. A shorter channel 112 or faster wave speed will result in a higher water hammer frequency.

To maximize the hydraulic pulse pressure ΔP, leakage through the gap 111 between the rotational disc valves 106 and 107 and the stationary disk 110 should be minimized.

This water hammer effect can produce pressure pulses A P several orders of magnitude higher than the static pressure present in the liquid before channel closure. These elevated hydraulic pulse pressures oscillate within the stationary disk 110 channel 112, with the number of pressure cycles largely determined by the length of channel 112, the rotational speed of the valves 106 and 107, and the pretreated mixture velocity in channel 112.

Elevated hydraulic pulse pressures A P, are generally advantageous for generating controlled pressure shockwaves. During processes like neutralization, where an emulsion of water-alkane solution droplets exists within an oil phase, these shockwaves are particularly useful. For example, when processing vegetable oil, it is challenging to manage the fine water-alkane droplets in the oil, especially when micelles formed by phospholipids and soaps are present.

Selectively controlled pressure shockwaves can excite oscillations in these water-alkane solution droplets, transferring pulse energy to the emulsion. By manipulating the pulsation frequency and duration, the oscillations of the emulsion droplets increase exponentially, resulting in unmatched mass transfer efficiency while avoiding the difficulties associated with fine emulsion formation. This technique rapidly creates uniformly sized droplets, a level of precision that conventional mixing methods cannot achieve.

Pressure pulsation frequency and duration pretreated mixture inside channel 112 will depend on the circumferential distance W between neighboring channels 109 on the rotatable disc valves 106 and 107 and rotation speed rotatable disc valves 106 and 107.

When two rotational disc valves 106 and 107 rotate and takes the entrance and exit end of the stationary disk 110 channel 112 from a closed position to an open position processed portion of the pretreated mixture is displaced from channel 112 by a new portion of unprocessed pretreated mixture.

A method has been discovered for an efficient, cost-effective vegetable oil refining process that reduces the formation of soap stocks or soaps during neutralization. The vegetable oil to be refined is pre-mixed with at least a reagent, e.g., acid and water, to form a feed supply. It has been surprisingly and unexpectedly found that by using a water hammer effect can significantly reduce the amount of soaps formed in the vegetable oil. The neutralization step is preferably carried out with a reactor inducing water hammer effect to the neutralization reaction that forms the lower-level soaps during reaction. A decrease in the number of soaps formed during vegetable oil refining can reduce the amount of oil loss and the costs related to separating and purifying the refined vegetable oil product. As such, an overall decrease in the number of soaps in the refined vegetable oil can be achieved by the methods of this disclosure while improving efficiency and reducing costs.

The oils that can be refined include vegetable oils, such as crude vegetable oil or water-degummed oil. Examples of vegetable oils can include, for example, acai oil, almond oil, babassu oil, black currant seed oil, borage seed oil, canola oil, cashew oil, castor oil, coconut oil, coriander oil, corn oil, cottonseed oil, crambe oil, flax seed oil, grape seed oil, hazelnut oil, hempseed oil, jatropha oil, jojoba oil, linseed oil, macadamia nut oil, mango kernel oil, meadowfoam oil, mustard oil, neat's foot oil, olive oil, palm oil, palm kernel oil, palm olein, peanut oil, pecan oil, pine nut oil, pistachio oil, poppy seed oil, rapeseed oil, rice bran oil, safflower oil, sasanqua oil, sesame oil, shea butter, soybean oil, sunflower seed oil, tall oil, tsubaki oil, walnut oil or combinations thereof.

The phosphatide or phosphorus content of the vegetable oil can be in the range of 30 to 3,000 ppm, 100 to 1,000 ppm, 200 to 800 ppm or 300 to 600 ppm. The phosphatide content (or also referred to as phospholipid content), as used herein, is expressed as ppm phosphorus in oil. In an example, the phosphatide content of crude oil, such as vegetable crude oil, can be in the range of 200 to 1,200 ppm phosphorus or as noted above. In another example, the phosphatide content of previously water-degummed oil, such as water-degummed vegetable oil, can be in the range of 30 to 200 ppm or 50 to 150 ppm phosphorus. A crud vegetable oil can have a phosphorous content in the range of 200 to 3,000.

The vegetable oil can be optionally heated prior to processing and neutralization, such as prior to acid being added to form an acid-treated vegetable oil. For example, the oil can be passed through a heat exchanger, such as a plate and frame heat exchanger, to increase or decrease the temperature of the vegetable oil as desired. The vegetable oil can be heated to a temperature in the range of 20 to 100° C., or at least to 30, 40, 50, 60, 60, 70, 80, 90 or 100° C. Preferably, the vegetable oil is maintained at a temperature in the range of 40 to 95° C. during the refining process as deemed suitable to one skilled in the art.

To form the acid-treated vegetable oil, acid is added to the vegetable oil. Acid is preferably added to the vegetable oil under stirring conditions, for example, in a vessel or tank equipped with a mixer or agitator. Mixing the vegetable oil and the acid can be for a period of time in the range of 15 minutes to 2 hours, or 30 minutes to 1 hour.

A base, such as an aqueous base solution, can be added to and mixed with the vegetable oil, for example, the acid-treated vegetable oil, to form a pretreated mixture.

The base can include sodium hydroxide, potassium hydroxide, sodium silicate, sodium carbonate, calcium carbonate, or combinations thereof. The base can be used in a range from at least 0.02 to 0.2 percent by weight based on the total weight of the vegetable oil. In another example, the base can be used in the range from 0.2 to 1 ppm base by weight based on the total weight of the vegetable oil, for instance, in the acid-treated vegetable oil stream. Concentrated base solutions, for instance, between 30 and 80 weight percent, can be used to reduce the amount of volume of base solution being added. Optionally, dilute solutions of base, for example 40 to 75 weight percent, can be used. Beyond the stoichiometric amount of base required to neutralize the acid and free fatty acids in the vegetable oil, surplus base can be added, for example, to adjust for certain vegetable oils to be refined and the quality thereof.

The reacted mixture is discharged from reactor 100 through outlet 105 for further processing, for example, the vegetable oil in the reacted mixture can be separated from the soaps. Also, water can be added to the reacted mixture prior to separating soaps from the mixture. The reacting mixture existing reactor 100 can be transferred into a vessel with a mixing chamber equipped with mixing means. Mixing means can include agitators, mixers, impellers or the like, for instance, a top-mounted impeller on a metal tank. The reacted mixture can be further mixed and retained in the vessel to further add water to the reacted mixture. The reacted mixture can be maintained by mixing for a period of 5 minutes to 2 hours, 15 minutes to 1.5 hours, 20 minutes to 1 hour, or 25, 30, 35, 40, 45 or 50 minutes. The vessel can be jacketed or equipped with another heating apparatus, such as coils, for maintaining the desired holding temperature, for example, in the range of 20 to 100° C., or at least 30, 40, 50, 60, 70, 80, 90 or 100° C.

The reacted mixture, whether discharged directly from reactor 100 or from the storage vessel after addition of water, can be further processed to prepare a refined vegetable oil product having a reduced number of soaps and impurities. For example, the reacted mixture can be transferred to one or more separation phases to remove the added water, acid, base, soaps or other components or a portion thereof and impurities from the vegetable oil phase to create a refined vegetable oil product. Prior to separation, the reacted mixture can be passed through a heat exchanger, to bring the mixture to desired temperature (e.g., 40 to 70° C.) prior to being processed in a separator. The reacted mixture, containing a water phase and an oil phase, can be processed to separate phases thereby removing soaps formed during the neutralization reaction (e.g., in reactor 100).

Separation of the soup stock from the oil phase can be done with a decanter, centrifuge, hydro cyclone or similar separation equipment.

In order to promote a further understanding of the invention, the following examples are provided. These examples are shown by way of illustration and not limitation.

### Example 1

A comparative example was prepared utilizing example traditional flow-through cavitation reactor processes.

Crude soybean oil with a phosphorus content of 620 ppm, 0.45% FFA, 274 ppm calcium and 186 ppm magnesium were heated to a temperature of approximately 85° C. 75 wt. % phosphoric acid was added to the crude canola oil, followed by 10 minutes mixing with speed of 250 rpm, to form an acid-treated vegetable oil. Caustic solution with 7.0% concentration was added to the acid-oil mixture and the mixture was subjected to a single pass through a 6 stage, flow-through cavitation reactor (disclose in U.S. Pat. No. 9,290,717) at an inlet pump pressure of 850 psi.

The reacted oil mixture was then directly fed to a vessel equipped with a stirrer and 2 wt. % of deionized water was added to the cavitated and reacted oil mixture was mixed with speed of 500 rpm at 80° C. for a period of 10 minutes retention time. The water-added reacted mixture samples were centrifuged for 5 minutes in lab centrifuge at 3,000 RPM, for separation of the soap stock, etc. from the soybean oil to prepare a refined soybean oil product. Soaps, phosphorus, free fatty acids, calcium and magnesium content of the refined soybean oils were determined from analysis of the light phase from centrifugation. The results are shown in Table 1.

TABLE 1
Hydrodynamic cavitation treated Crude Soybean Oil

| | |
|---|---|
| FFA [%] | 0.073 |
| Soap [ppm] | 180 |
| Phosphorus [ppm] | 6 |
| Calcium content [ppm] | 0.75 |
| Magnesium content [ppm] | 0.42 |

### Example 2

A comparative example was prepared utilizing example of proposed water hammer shock pressure pulsation degumming method and reactor.

The same crude soybean oil from Example 1 was treated by using hydro shock pressure pulsation reactor containing two rotational disc valves 106 and 107 and stationary disk 110 channel 112 having diameter 4.5 mm and length 5 mm. Rotational speed rotational disc valves 106 and 107 was 3,000 RPM and velocity in channel 112 was 8.1 m/sec. Pressure pulsation frequency was 290 kHz.

Caustic solution with 7.0% concentration was added to the acid-oil mixture in front of the reactor and the mixture was subjected to a single pass through the reactor. The reacted oil mixture was then directly fed to a vessel equipped with a stirrer and 2 wt. % of deionized water was added to the cavitated and reacted oil mixture was mixed with speed of 500 rpm at 80° C. for a period of 10 minutes retention time. The water-added reacted mixture samples were centrifuged for 5 minutes in lab centrifuge at 3,000 RPM, for separation of the soap stock, etc. from the soybean oil to prepare a refined soybean oil product. Soaps, phosphorus, free fatty acids, calcium and magnesium content of the refined soybean oils were determined from analysis of the light phase from centrifugation. The results are shown in Table 2.

TABLE 2
Improved method treated Crude Soybean Oil

| | |
|---|---|
| FFA [%] | 0.038 |
| Soap [ppm] | 48 |
| Phosphorus [ppm] | 1.47 |
| Calcium content [ppm] | 0.05 |
| Magnesium content [ppm] | 0.03 |

As can be seen from Tables 1 and 2, the phosphatide content of an oil subjected to the new degumming method can be lowered by 75.5% as compared to the traditional cavitation processes. Soaps also were lowered by 73% lowered by 75.5%. Content calcium and magnesium also was significantly reduced.

The present invention creates beneficial conditions that cannot be duplicated by prior art. The beneficial effects gained through the present invention cannot be achieved through prior art cavitation methods because the conditions created by the water hammer hydraulic pulse pressure cannot be duplicated by other means.

It will be understood that this invention is not limited to the above-described embodiments. Those skilled in the art having the benefit of the teachings of the present invention as hereinabove set forth, can effect numerous modifications thereto. These modifications are to be construed as being encompassed with the scope of the present invention as set forth in the appended claims. It will be apparent to those skilled in the art that many modifications, variations, substitutions, and equivalents for the features described above may be effected without departing from the spirit and scope of the invention as defined in the claims to be embraced thereby. A preferred embodiment has been described, herein. It will be further apparent to those skilled in the art that the above methods may incorporate changes and modifications without departing from the general scope of this invention. It is intended to include all such modifications and alterations in so far as they come within the scope of the appended claims or the equivalents thereof.

What is claimed is:

1. Method for degumming triglyceride oils comprising:
(a) mixing an aqueous base with an acid-treated oil stream to obtain a pretreated oil mixture;
(b) subjecting the pretreated oil mixture to oscillated pressure impulses by passing a flow of the pretreated oil mixture through at least one channel, and
(c) generating water hammer hydraulic pulse pressure inside the channel by periodically closing an inlet and an outlet of the channel simultaneously for a closing time period calculated using the equation:
t≥2L/c,
where t is the time in seconds to close the inlet and the outlet of the channel, L is the length of the channel in meters, and c is the speed of sound in the pretreated oil mixture in meters per second.

2. The method according to claim 1, wherein the closing of the inlet and the outlet of the channel is performed by two rotational disc valves.

3. The method of claim 1, wherein the acid-treated oil stream is an acid-treated crude vegetable oil or an acid-treated water-degummed vegetable oil.

4. The method of claim 1, wherein the acid in the acid-treated oil stream is selected from the group consisting of phosphoric acid, hydrochloric acid, sulfuric acid, ascorbic acid, acetic acid, citric acid, fumaric acid, maleic acid, tartaric acid, succinic acid, glycolic acid and a combination thereof.

5. The method of claim 1, wherein the aqueous base is selected from the group consisting of sodium hydroxide, potassium hydroxide, sodium silicate, sodium carbonate, calcium carbonate and a combination thereof.

6. The method of claim 1, wherein the oil in the acid-treated oil stream is selected from the group consisting of acai oil, almond oil, babassu oil, blackcurrant seed oil, borage seed oil, canola oil, cashew oil, castor oil, coconut oil, coriander oil, corn oil, cottonseed oil, crambe oil, flax seed oil, grape seed oil, hazelnut oil, hempseed oil, jatropha oil, jojoba oil, linseed oil, macadamia nut oil, mango kernel oil, meadowfoam oil, mustard oil, neat's foot oil, olive oil, palm oil, palm kernel oil, palm olein, peanut oil, pecan oil, pine nut oil, pistachio oil, poppy seed oil, rapeseed oil, rice bran oil, safflower oil, sasanqua oil, sesame oil, shea butter, soybean oil, sunflower seed oil, tall oil, tsubaki oil, walnut oil and a combination thereof.

7. The method of claim 1, wherein the acid-treated oil stream is at a temperature in the range of 50 to 100° C.

8. A reactor for degumming vegetable oils, the reactor comprising a housing having an inlet through which a liquid pretreated mixture is introduced into a chamber of the reactor and an outlet downstream from the inlet through which the liquid pretreated mixture is discharged;
(a) two rotational disc valves mounted for rotation in the chamber on a shaft, having a series of circumferential channels extending through a rotatable plate parallel to the central axis of the chamber,
(b) a stationary disk plate joined with an inner wall of the chamber, perpendicular to the central axis of the chamber, disposed between the two rotatable discs valves and closely adjacent to the rotatable discs valves, containing at least one elongated channel, extend through the stationary disk plate parallel to the central axis of the chamber, wherein the radii from the central axis of the chamber to the central axes of all the channels being the same for the stationary disk plates and the rotational disc valves.

9. The reactor of claim 8, wherein all of the circumferential channels of the rotational disc valves have coinciding central axes.

10. The reactor of claim 8, wherein the circumferential distance between neighboring channels of the rotational disc valves is at least equal to the diameter of the channel in the stationary disk plate.

11. The reactor of claim 8, comprising more than one set of stationary and rotatable disks valves arranged in series axially in the chamber and separated from one another by respective spacings.

12. The reactor of claim 8, wherein the shaft is connected to a motive means effectively rotating the rotational disc valves.
